(19) United States
(12) Patent Application Publication
(10) Pub. No.: US 2026/0152205 A1
(43) Pub. Date: Jun. 4, 2026

(54) METHOD FOR GENERATING VIBRATIONS IN AN ELECTRIC VEHICLE

(71) Applicant: BRP-ROTAX GMBH & CO. KG, Gunskirchen (AT)

(72) Inventors: Florian MEIER, Pasching (AT); Steffen MEYER-SALFELD, Leonberg (DE); Walter HINTERBERGER, Taufkirchen an der Trattnach (AT)

(21) Appl. No.: 19/393,082

(22) Filed: Nov. 18, 2025

Related U.S. Application Data
(60) Provisional application No. 63/726,352, filed on Nov. 29, 2024.

(51) Int. Cl. B60W 50/16; B60W 10/08

(52) U.S. Cl. CPC B60W 50/16; B60W 10/08; B60W 2300/36

(57) ABSTRACT

Method of generating vibrations in an electric vehicle and electric vehicle thereof. The method being executed by a controller of the electric vehicle. The method includes providing a signal for operating the electric motor and selecting one of a first driver-contacting component or a second driver-contacting component to be vibrated. The method continues with adjusting the signal for causing vibration of the electric motor at a desired frequency. The desired frequency is at or near a resonance frequency of one of the first or the second driver-contacting components. The method continues with applying the adjusted signal to the electric motor.

### CROSS-REFERENCE

The present application claims priority to U.S. Provisional Patent Application No. 63/726,352, filed on Nov. 29, 2024, which is incorporated herein by reference in its entirety.

### FIELD OF TECHNOLOGY

The present technology relates to electric vehicles, and specifically to methods for generating vibrations in said electric vehicles.

### BACKGROUND

Electric vehicles are valued for their efficiency and environmental benefits, offering a sustainable alternative to traditional internal combustion engine vehicles. Central to their operation is the electric motor, which serves as the primary source of propulsion.

Controlled vibrations in electric vehicles can be used to convey various types of information to the driver through haptic feedback. For example, vibrations can be used to alert the driver to vehicle conditions such as low battery or navigation prompts, in a non-intrusive manner.

Typically, this is achieved by providing an electric motor dedicated to vibration generation in the electric vehicle. However, the additional motor adds to the weight, as well as the complexity and cost of manufacturing the electric vehicle.

There is therefore a desire for generating vibrations in electric vehicles that can overcome at least some of the above-described drawbacks.

### SUMMARY

It is an object of the present technology to ameliorate at least some of the inconveniences present in the prior art.

According to one aspect of the present technology, there is provided a method for generating vibrations in an electric vehicle having an electric motor for propelling the electric vehicle, the method includes: providing, by a controller of the electric vehicle, a signal for operating the electric motor; selecting, by the controller, one of a first driver-contacting component or a second driver-contacting component to be vibrated; adjusting, by the controller, the signal for causing vibration of the electric motor at a desired frequency, the desired frequency being at or near a resonance frequency of the one of the first driver-contacting component or the second driver-contacting component; and applying, by the controller, the adjusted signal to the electric motor.

In some embodiments, the method further includes detecting, by at least one condition sensor operatively connected to the controller, at least one condition of the electric vehicle.

In some embodiments, the method further includes receiving, by the controller, a condition signal indicative of the at least one detected condition of the electric vehicle; and wherein selecting the one of the first driver-contacting component or the second driver-contacting component and adjusting the signal is based on the condition signal.

In some embodiments, adjusting the signal includes modulating the signal to cause the one of the first driver-contacting component or the second driver-contacting component to vibrate in a vibration pattern based on the condition signal.

In some embodiments, adjusting the signal includes modulating a frequency of the signal based on the condition signal.

In some embodiments, adjusting the signal includes modulating an amplitude of the signal based on the condition signal.

In some embodiments, the first driver-contacting component is at least one of a left handle, a right handle, or a handlebar of the electric vehicle; and the second driver-contacting component is a driver seat of the electric vehicle.

In some embodiments, the first driver-contacting component has a first resonance frequency; the second driver-contacting component has a second resonance frequency; and the first resonance frequency is higher than the second resonance frequency.

In some embodiments, the signal is a magnetizing current component.

In some embodiments, adjusting the signal includes adding an adjustment value to the magnetizing current component.

In some embodiments, the method includes detecting, by at least one drive system sensor operatively connected to the controller, at least one drive system parameter of the electric vehicle.

In some embodiments, the method further includes receiving, by the controller, a drive system signal indicative of the at least one detected drive system parameter; and adjusting the signal to the adjusted signal is performed based on the drive system signal.

In some embodiments, the at least one detected drive system parameter is at least one of a motor load, high vehicle acceleration, a rotor angular position, vehicle operation limits, a driving mode, and a drivetrain operating parameter.

In some embodiments, the method is performed independently of a torque output of the electric motor.

According to another aspect of the present technology, there is provided an electric vehicle having a vehicle body; an electric motor mounted to the vehicle body for driving the electric vehicle; a first driver-contacting component connected to the vehicle body the first driver-contacting component having a first resonance frequency; a second driver-contacting component connected to the vehicle body, the second driver-contacting component having a second resonance frequency; and a controller operatively connected to the electric motor, the controller being configured for: providing a signal for operating the electric motor; selecting one of the first driver-contacting component or the second driver-contacting component to be vibrated; and adjusting the signal for causing vibration of the electric motor at a desired frequency that is at or near the first resonance frequency or the second resonance frequency corresponding to the one of the first driver-contacting component or the second driver-contacting component; and applying the adjusted signal to the electric motor.

In some embodiments, the first driver-contacting component is at least one of a left handle, a right handle, or a handlebar; and the second driver-contacting component is a driver seat.

In some embodiments, the method further includes at least one condition sensor operatively connected to the controller for detecting at least one condition of the electric vehicle.

In some embodiments, the controller is further configured for: receiving a condition signal from the at least one condition sensor indicative of the at least one detected condition of the electric vehicle; and wherein selecting the one of the first driver-contacting component or the second driver-contacting component and adjusting the signal is based on the condition signal.

In some embodiments, when the controller is adjusting the signal, the controller is further configured for modulating the signal to cause the one of the first driver-contacting component or the second driver-contacting component to vibrate in a vibration pattern based on the condition signal.

In some embodiments, when the controller is adjusting the signal, the controller is further configured for modulating at least one of a frequency and an amplitude of the signal.

In some embodiments, the method further includes at least one drive system sensor for detecting a drive system parameter of the electric vehicle.

In some embodiments, wherein the controller is further configured to: receive a drive system signal from the at least one drive system sensor indicative of the at least one detected drive system parameter; and adjusting the signal in response to the detected drive system parameter.

In some embodiments, the controller implements a field-oriented control to adjust the signal.

In some embodiments, the vehicle body includes: a frame having; a pair of frame members; and a swing arm pivotally connected to the pair of frame members; the electric motor is mounted to the swing arm; and the electric vehicle further includes at least one ground-engaging member operatively connected to the swing arm.

In some embodiments, the electric vehicle is an electric motorcycle; the at least one ground-engaging member includes a front ground-engaging member and a rear ground-engaging member; and the electric motor is operatively connected to the rear ground-engaging member for driving the at rear ground-engaging member.

For the purposes of the present application, terms related to spatial orientation such as forward, rearward, front, rear, upper, lower, left, and right, are as they would normally be understood by a driver of the electric vehicle sitting therein in a normal driving position with the electric vehicle being upright and steered in a straight ahead direction.

For purposes of the present application, the term “driver-contacting component” refers to a component of a vehicle with which a driver of the vehicle is normally in contact with during normal use, such as a handlebar, a seat, or footrests for example.

It must be noted that, as used in this specification and the appended claims, the singular form “a”, “an”, and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B, and (iii) A and B, just as if each is set out individually herein.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, rear, right side perspective view of an electric motorcycle according to a non-limiting embodiment of the present technology;

FIG. 2 is a top plan view of the vehicle of FIG. 1;

FIG. 3 is left side elevation view of the vehicle of FIG. 1;

FIG. 4 is a right side elevation view of the vehicle of FIG. 1, with body panels having been removed;

FIG. 5 is a left side elevation view of the vehicle of FIG. 1, with body panels having been removed;

FIG. 6 is a top, front, left side perspective view of a frame, a powerpack, a drivetrain, and a swing arm of the vehicle of claim 1, with a housing cover of the swing arm having been removed;

FIG. 7 is a top, rear, right side, exploded, perspective view of a motor and the swing arm of the vehicle of FIG. 1;

FIG. 8 is a schematic cross-sectional view of the electric motor of the vehicle of FIG. 1 taken along line 8-8 of FIG. 7;

FIG. 9 is a block diagram of a illustrating a controller and associated sensors of the vehicle of FIG. 1; and

FIG. 10 is a flow chart of a method for generating vibrations in an electric vehicle.

It should be noted that, unless otherwise explicitly specified herein, the drawings are not necessarily to scale.

### DETAILED DESCRIPTION

The present technology will be described herein with respect to a straddle-seat electric vehicle, specifically a two-wheeled electric motorcycle 100. Aspects of the present technology could also be implemented in different types of electric vehicles such as a three-wheeled electric vehicle or an electric personal watercraft.

While the motorcycle 100 illustrated herein is a trail style electric motorcycle 100, it is contemplated that motorcycles according to the present technology could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheel base.

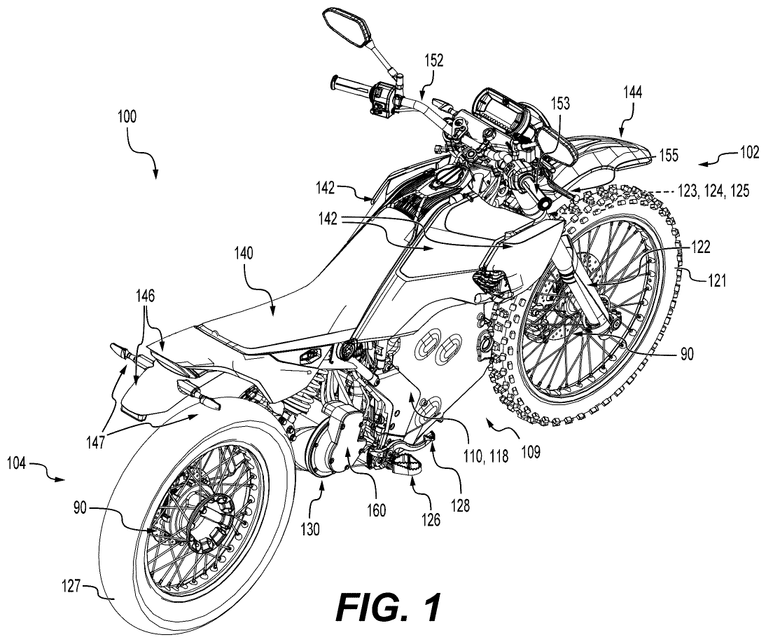

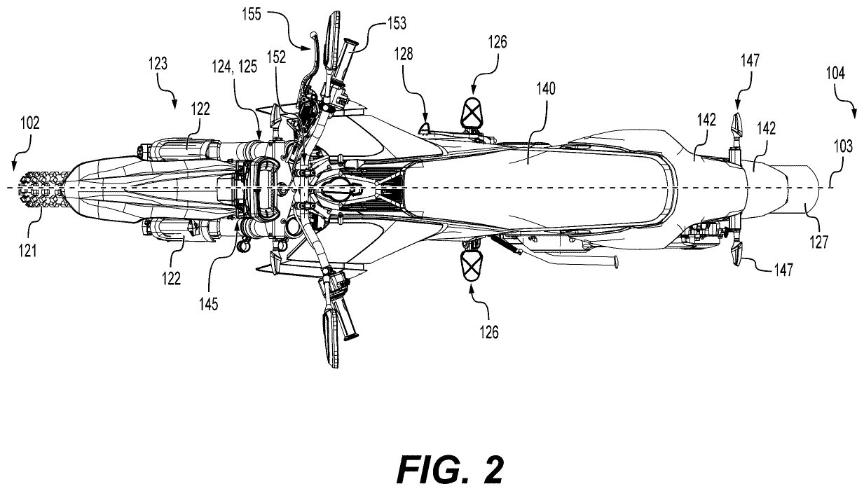

With reference to FIGS. 1 to 5, the electric motorcycle 100, referred to herein as the electric vehicle 100, has a front end 102, a rear end 104, and a longitudinal center plane 103 defined consistently with the forward travel direction of the electric vehicle 100.

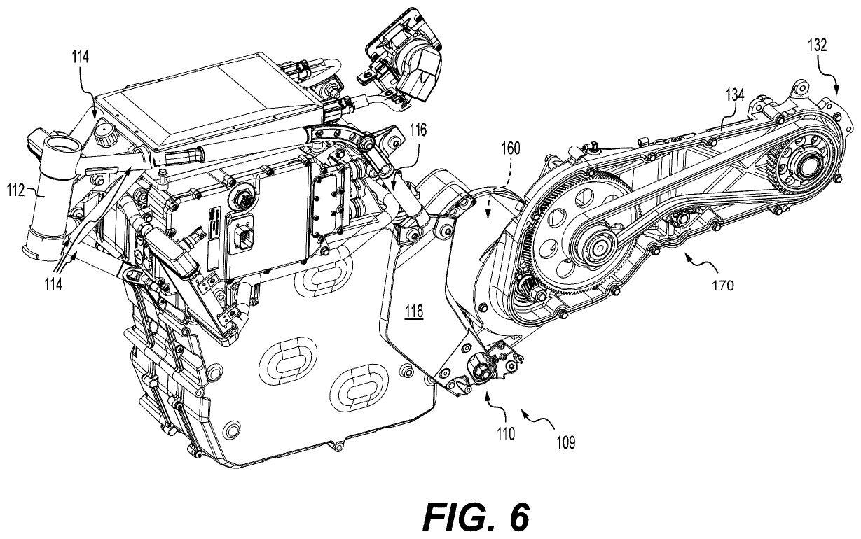

The electric vehicle 100 has a vehicle body 109 which includes a frame 110, shown in additional detail in FIG. 6. The frame 110 includes a front suspension receiving portion 112, specifically a tube 112, sometimes referred to as a “head tube”, for receiving therethrough a front fork assembly 124 (described in more detail below). Extending rearward from the tube 112, the frame 110 includes forward frame members 114. In the illustrated embodiment, there are six forward frame members 114 (three on each side of the center plane 103) but it is contemplated that the specific number and arrangement of forward frame members 114 could vary.

The frame 110 also includes two upper intermediate frame members 116 extending rearward from the forward members 114. The frame members 116 are generally hockey-stick shaped, with rear portions of the members 116 curving rearward and downward from generally horizontal forward portions of the members 116. In different embodiments, the frame members 116 could be differently shaped.

The frame 110 further includes two lower intermediate frame members 118 connected to rear ends of the frame members 116. The frame members 118 extend generally vertically along left and right sides of the electric vehicle 100. The frame members 118 are generally in the shape of flattened boomerangs, but the particular shape could vary. It is contemplated that the frame members 118 could be left and right sides of a common frame bracket.

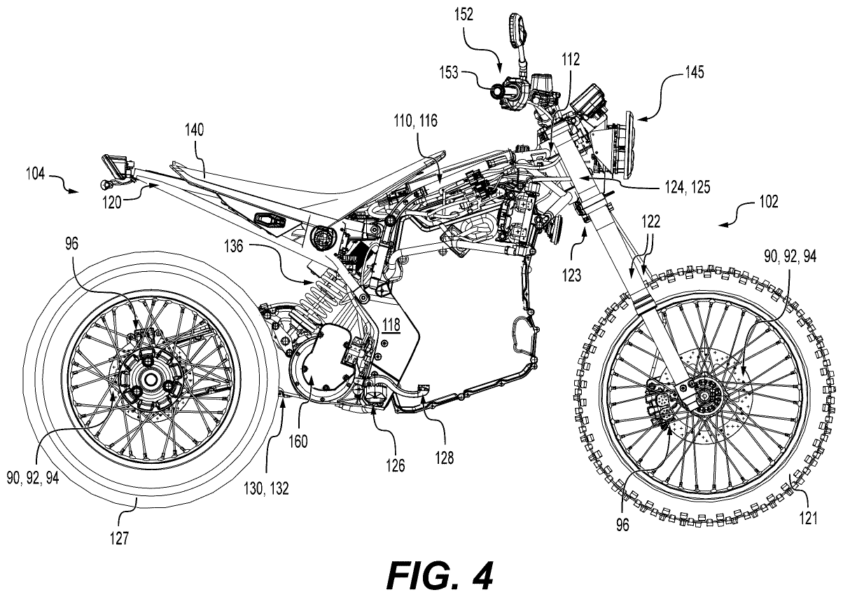

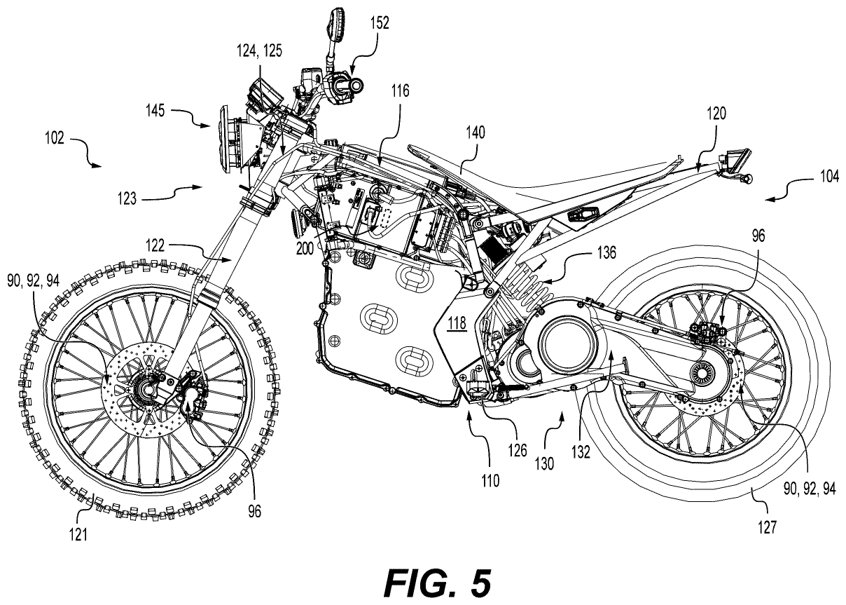

The frame 110 further includes a rear frame structure 120 (FIGS. 4 and 5) connected to and extending rearward and slightly upward from the upper intermediate frame members 116 and the lower intermediate frame members 118 (omitted from FIG. 6). The rear frame structure 120 is also referred to as a seat support structure 120. It is contemplated that the frame 110 could include additional frame members, including but not limited to additional intermediate frame members and additional rear frame members.

The electric vehicle 100 is a two-wheeled vehicle 100 including a front wheel 121 and a rear wheel 127. The front wheel 121 and the rear wheel 127 each have a tire secured thereto. The front wheel 121 and the rear wheel 127 are centered with respect to the longitudinal center plane 103.

The front wheel 121 is connected to the frame 110 by a front suspension assembly 123. The front suspension assembly 123 includes a front fork assembly 124 for supporting the front end 102 of the electric vehicle 100. The front fork assembly 124 includes a triple clamp assembly 125 connected to the tube 112 of the frame 110. The front fork assembly 124 includes a pair of front shocks 122 connected to the triple clamp assembly 125. The front wheel 121 of the front fork assembly 124 is connected to a bottom portion of the pair of front shocks 122.

The rear wheel 127 mounted to the frame 110 by a rear suspension assembly 130. The rear suspension assembly 130 includes a swing arm 132 and a shock absorber 136. The swing arm 132 is pivotally mounted at a front thereof to the frame 110. More specifically, the front of the swing arm 132 is received between lower portions of the lower intermediate frame members 118. The swing arm 132 pivots relative to the lower intermediate frame members 118 about a swing arm pivot axis (not separately numbered) that extends through the lower intermediate frame members 118. As best seen in FIG. 6, the swing arm 132 includes a swing arm housing 134, in which is disposed an electric motor 160 and a drivetrain 170. The swing arm 132 includes a housing cover (not depicted) selectively removable from the housing 134. The swing arm housing 134 and the housing cover enclose the drivetrain 170. When the housing cover is in place, the drivetrain 170 is bathed in lubricant within the swing arm 132.

The rear wheel 127 is rotatably mounted to the rear end of the swing arm 132 which extends on a left side of the rear wheel 127. The shock absorber 136 is connected between the swing arm 132 and the frame 110, specifically to the intermediate frame members 116. It is contemplated that the relative arrangement of the shock absorber 136 and the frame 110 could vary in different embodiments. The electric motor 160 and the drivetrain 170 will be described in more detail below.

The electric vehicle 100 has a straddle seat 140 mounted to the frame 110, specifically to the rear frame structure 120, and disposed along the longitudinal center plane 103. In the illustrated embodiment, the straddle seat 140 is intended to accommodate a single adult-sized rider, i.e. the driver. It is however contemplated that the seat 140 could be longer or that a passenger seat portion could be connected to the rear frame structure 120 in order to accommodate a passenger behind the driver. Depending on the particular embodiment, it is also contemplated that the seat 140 could be supported by an assembly of frame members or tubes, a molded portion integrally connected to the seat 140, or body panels of the motorcycle 100.

The electric vehicle 100 further includes a plurality of body panels 142 for forming the body of the electric vehicle 100, illustrated in FIGS. 1 to 3. The body panels 142 are connected to and supported by the frame members 114, 116. The body panels 142 enclose and protect some internal components of the electric vehicle 100 such as a powerpack (not separately numbered). The electric vehicle 100 also includes a front fender 144 disposed at the front of the electric vehicle 100 and extending partially over the front wheel 121. Rearward of the seat 140, the electric vehicle 100 also has rear fender panels 146 extending at least partially over rear wheel 127. The electric vehicle 100 includes front headlights 145 attached to the front fork assembly 124 and electrically connected to a battery pack (not separately numbered). The electric vehicle 100 also has rear braking and indicator lights 147 supported by the rear panels 146 and electrically connected to the battery pack.

Depending on the particular embodiment, especially between different motorcycle types (trail-style motorcycle or cruiser-style motorcycle for example), the body panels 142 and the fenders 144, 146 could be different in shape and number. For example, some embodiments of the electric vehicle 100 could include a mud flap connected to a rear edge of one of the body panels 142. It is further contemplated that one or both of the fenders 144 and rear panels 146 could be omitted in some cases.

A driver footrest 126 is disposed on either side of the electric vehicle 100 and vertically lower than the straddle seat 140 to support the driver's feet. The driver footrests 126 are connected to the frame members 118. It is contemplated that the footrests 126 could be implemented in various forms other than those illustrated, including but not limited to pegs and footboards. It is contemplated that the electric vehicle 100 could also be provided with one or more passenger footrests disposed rearward of the driver footrest 126 on each side of the electric vehicle 100, for supporting a passenger's feet when a passenger seat portion for accommodating a passenger is connected to the electric vehicle 100. A brake pedal 128 is connected to the right driver footrest 126 for braking the electric vehicle 100. The brake pedal 128 extends upwardly and forwardly from the right driver footrest 126 such that the driver can actuate the brake pedal 128 with a front portion of the right foot while a rear portion of the right foot remains on the right driver footrest 126.

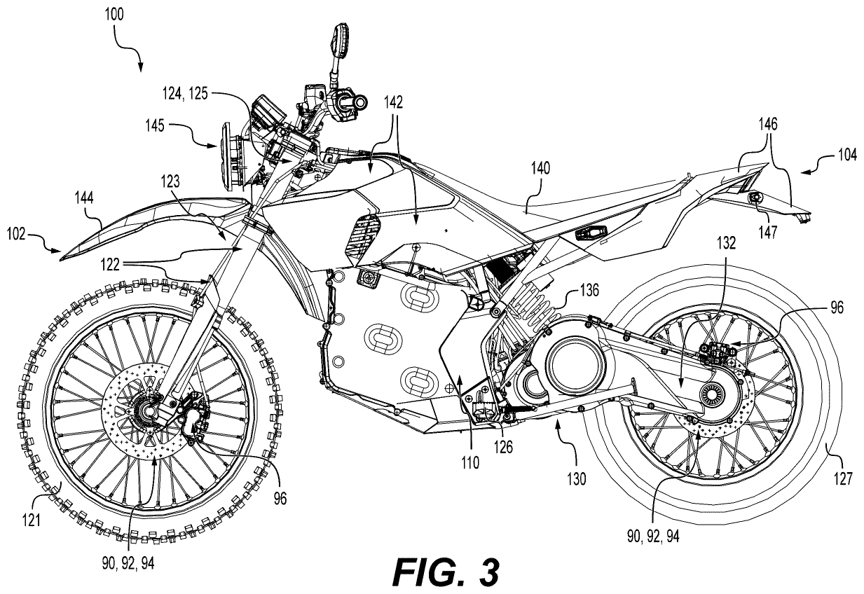

With reference to FIGS. 3 to 5, each of the front wheel 121 and the rear wheel 127 is provided with a brake assembly 90. The brake assemblies 90 of the wheels 121, 127, along with the brake pedal 128, form part of a brake system 92. Each brake assembly 90 is a disc-type brake mounted onto the spindle of the respective wheel 121 or 127. Other types of brakes are contemplated. Each brake assembly 90 includes a rotor 94 mounted onto the wheel hub and a stationary caliper 96 straddling the rotor 94. The brake pads (not shown) are mounted to the caliper 96 so as to be disposed between the rotor 94 and the caliper 96 on either side of the rotor 94. The brake pedal 128, as well as a hand-operated brake lever 155 described below, are operatively connected to the brake assemblies 90 provided on each of the front wheel 121 and the rear wheel 127. The brake system 92 further includes a regenerative braking system (not shown) that uses the electric motor 160 as a generator to charge battery cells of the battery pack while slowing the electric vehicle 100.

Returning to FIGS. 1 to 5, the electric vehicle 100 includes a handlebar assembly 152 operatively connected to the front fork assembly 124 and disposed in front of the seat 140. The handlebar assembly 152 is used by the rider to turn the front wheel 121, via the front fork assembly 124, to steer the electric vehicle 100. Specifically, the handlebar assembly 152 is connected to a top end of the triple clamp assembly 125. The handlebar assembly 152 and the triple clamp assembly 125 define a steering axis about which the front wheel 121 turns to steer the electric vehicle 100. A twist-grip throttle 153 is operatively connected on the right side of the handlebar assembly 152 for controlling vehicle speed. It is contemplated that the twist-grip throttle 153 could be replaced by a throttle lever or some other type of throttle input device. The twist-grip throttle 153 could be disposed on the left side of the handlebar assembly 152 in some embodiments. The handlebar assembly 152 also includes the brake lever 155 on a right side for activating the brake assemblies 90.

It is contemplated that the electric vehicle 100 could include a variety of different features excluded from discussion here, including but not limited to: a windscreen, radio and/or navigational systems, and luggage rack systems.

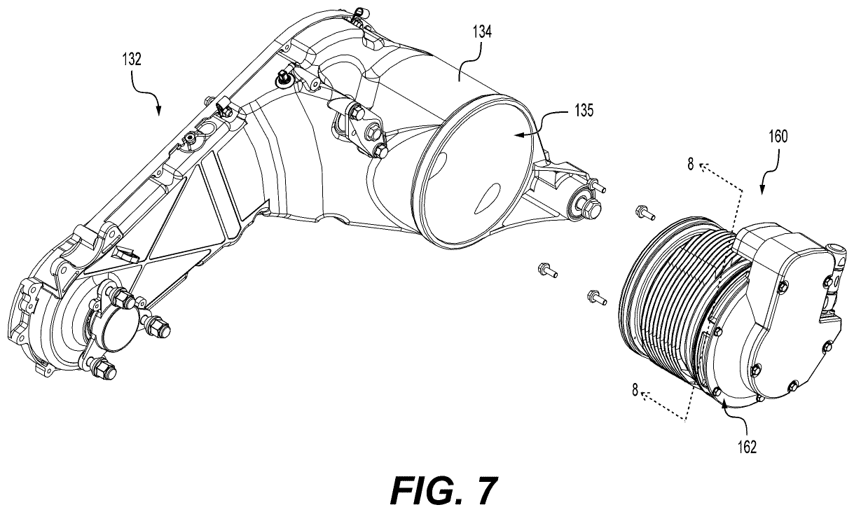

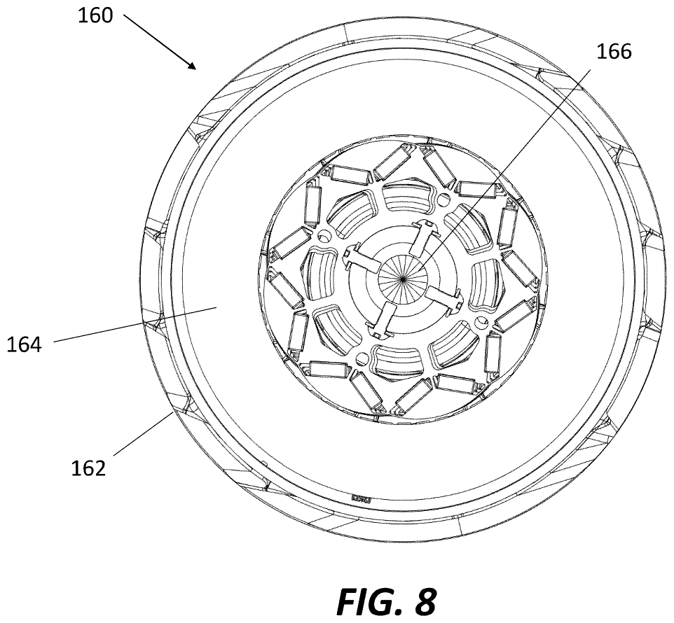

With reference to FIGS. 6 to 8, the electric motor 160 is mounted to the swing arm 132. In this embodiment, the electric motor 160 is disposed in the swing arm 132. As the swing arm 132 pivots relative to the frame 110, the electric motor 160 moves with the swing arm 132. In the present embodiment, the electric motor 160 is a three-phase electric motor 160. However, it is contemplated that different types of motors could be used in different embodiments.

The electric motor 160 includes a motor housing 162 for housing a stator 164 and a rotor 166. The stator 164 is the stationary part of the electric motor 160. In the present embodiment, the stator 164 includes windings (not depicted) which generates a magnetic field when energized. It is contemplated that, in other types of electric motors 160, the stator 164 may use magnets (not separately numbered) to generate the magnetic field. The rotor 166 is positioned in the stator 164 and rotates relative to the stator 164. In the present embodiment, the rotor 166 includes permanent magnets embedded in a core (not separately numbered). When the stator 164 generates a rotating magnetic field, it interacts with the permanent magnets, thus producing torque which drives the rotational motion of the rotor 166, thereby powering the output of the electric motor 160.

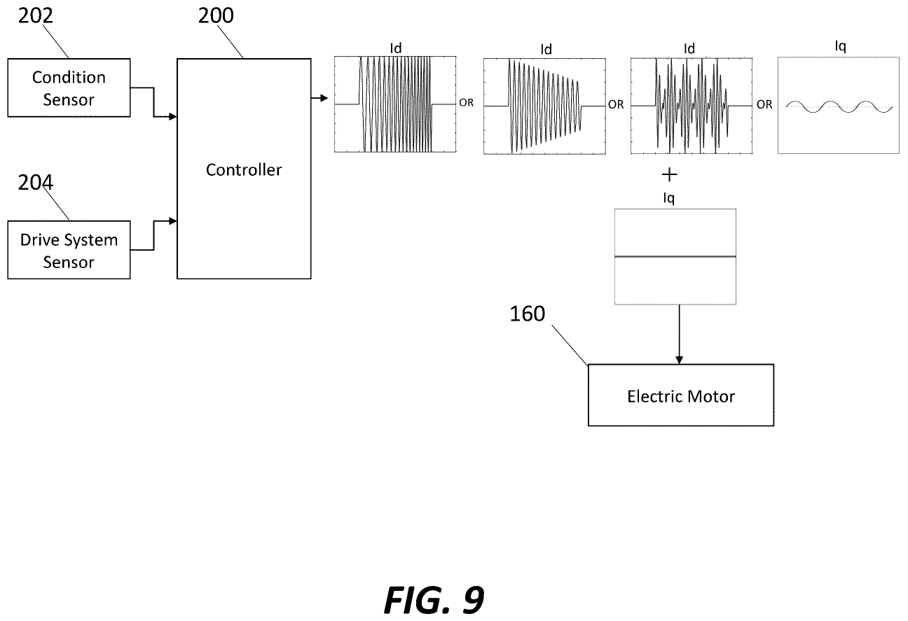

The electric vehicle 100 includes a controller 200 (depicted schematically in FIGS. 5 and 9) operatively connected to the electric motor 160. The controller 200 is configured to execute a method 300 of generating vibrations in the electric vehicle 100, which is described in detail below.

The controller 200 is operatively connected to at least one condition sensor 202 (depicted schematically in FIG. 9) for detecting a condition of the electric vehicle 100. In some embodiments, the condition sensor 202 may be configured to detect potential dangers (i.e., road conditions, distances from adjacent vehicles, merging lanes, traction limits, etc.), speed limits, traffic signs, and/or navigation information. The detected condition is transmitted to and received by the controller 200 as a condition signal, which is described in detail below. The number and type of condition sensors 202 may vary in other embodiments such that any number and/or any type of vehicle condition may be sent as condition signals. It is contemplated that, in some embodiments, the at least one condition sensor 202 may be omitted.

The controller 200 is further operatively connected to at least one drive system sensor 204 (depicted schematically in FIG. 9) for detecting a drive system parameter of the electric vehicle 100. For instance, in certain embodiments, the drive system sensor 204 may detect at least one of a motor load, high vehicle acceleration, a drivetrain operating parameter, a rotor angular position, vehicle operation limits (i.e., vehicle temperature, overload, state of charging, etc.), and a driving mode selected by the driver,. The detected drive system parameter, by the drive system sensor 204, is transmitted to and received by the controller 200 as a drive system signal, which is described in detail below. The number and type of drive system sensors 204 may vary in other embodiments such that any number and/or any type of drive system parameters may be sent as drive system signals. It is contemplated that, in some embodiments, the at least one drive system sensor 204 may be omitted.

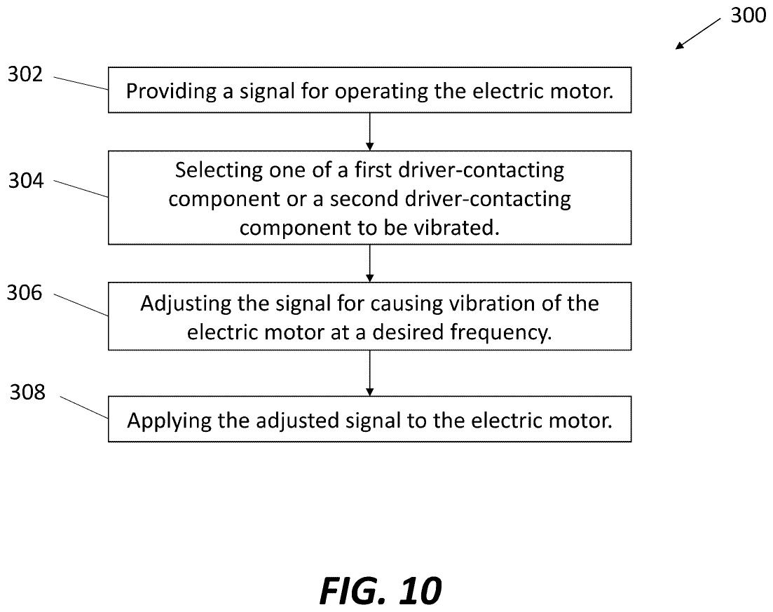

With reference to FIG. 10, the method 300 for generating vibrations in the electric vehicle 100 will now be described. Broadly, the method 300 induces vibrations within the electric motor 160 which are at or near a resonance frequency of either a first driver-contacting component or a second driver-contacting component. This allows information to be conveyed to the driver of the electric vehicle 100 through haptic feedback of the respective driver-contacting component. For instance, the first driver-contacting component vibrating may relay one type information to the driver while the second driver-contacting component vibrating may relay another type of information to the driver. In the present embodiment, the first driver-contacting component is the handlebar assembly 152 and the second driver-contacting component is the driver straddle seat 140. However, it is contemplated that the first and second driver-contacting components may vary in other embodiments, for example the first or second driver-contacting component may include a left or a right handle of the handlebar assembly 152, or one or both of the driver footrests 126. It is also contemplated that in some embodiments, the method 300 could induce vibrations in more than two driver-contacting components. It is appreciated that, during normal operation of the electric vehicle 100, vibrations are present. However, the vibrations generated during the method 300 will cause the first driver-contacting component or the second driver-contacting component to vibrate more intensely than the vibrations experienced during normal operations. It is noted that the order of the steps of the method 300 is shown as an example, and therefore the steps of the method 300 may vary in other embodiments.

The method 300 begins, at step 302, with providing a signal to the electric motor 160 for operating the electric motor 160. In the present embodiment, the signal is a magnetizing component of a current. Specifically, the controller 200 implements a field-oriented control to separate the current provided to the electric motor 160 into the magnetizing component (sometimes referred to as the “d-axis current” or “Id”) and a torque component (sometimes referred to as the “q-axis current” or “Iq”). The magnetizing component primarily controls the magnetic field of the electric motor 160, while the torque component is responsible for producing torque by influencing the rotational force of the electric motor 160.

As described above, the controller 200 is operatively connected to the condition sensor 202, which detects the condition of the electric vehicle 100. In this embodiment, the method 300 includes the condition sensor 202 detecting the condition of the electric vehicle 100 and transmitting the condition signal, indicative of the condition of the electric vehicle 100, to the controller 200. The method 300 continues with the controller 200 receiving said condition signal from the condition sensor 200.

The method 300 continues, at step 304, with selecting one of the handlebar assembly 152 or the driver straddle seat 140 to be vibrated. For clarity, the selected one of the handlebar assembly 152 or the driver straddle seat 140 will be referred to herein as “the selected component”. In the present embodiment, the selection of the selected component is based on the condition signal, allowing different vehicle conditions to be communicated to the driver based on whether the handlebar assembly 152 or the driver straddle seat 140 is vibrating. For example, if the controller 200 is operatively connected to a camera, for detecting environmental hazards around the electric vehicle 100, as well as a navigation system, the controller 200 may select the driver straddle seat 140 to vibrate when a road hazard is detected by the camera and may select the handlebar assembly 152 to vibrate when there is a navigation prompt from the navigation system. It is contemplated that, in other embodiments, step 304 may be based on additional or different information received by the controller 200.

As described above, the controller 200 is operatively connected to the drive system sensor 204, which detects the drive system parameter of the electric vehicle 100. In this embodiment, the method 300 includes the drive system sensor 204 detecting the drive system parameter and transmitting the drive system signal, indicative of the drive system parameter, to the controller 200. The method 300 continues with the controller 200 receiving the drive system signal from the drive system sensor 204. The controller 200 will determine whether to proceed with the method 300 based on the drive system signal. For example, if the drive system sensor 204 detects the electric motor 160 is under a high load, the controller 200 may not proceed with the method 300 to mitigate risk of overloading the electric motor 160. It is contemplated that the controller 200 may assess other vehicle parameters or vehicle information in addition to the drive system signal. For example, the controller 200 may determine whether to proceed with the method 300 based on the condition signal, as well as the drive system signal.

If the controller 200 determines the method 300 can proceed, it continues, at step 306, with adjusting the magnetizing component of the current to cause the electric motor 160 to vibrate at a desired frequency. In the present embodiment, adjusting the magnetizing component of the current is based on the condition signal received by the controller 200. Specifically, as described above, the selected component is based on the condition signal, and thus the magnetizing component of the current is adjusted based on the condition signal such that the electric motor 160 is vibrated at or near the resonance frequency of the selected component.

At step 306, the controller 200, using the field-oriented control, adds an adjustment value to the magnetizing current component, thereby affecting the magnetic field of the stator which changes a radial magnetic force between the stator 164 and the rotor 166. If this change in radial magnetic force is symmetric, it causes deformation of the stator 164, such as a local increase or decrease of the radial dimensions of the stator 164, thereby inducing vibrations of the electric motor 160 at the desired frequency. If the change in radial magnetic force is asymmetric, the rotor 166 experiences small displacements from its rotational axis (not separately numbered), resulting in acceptable unbalanced rotations, and thereby inducing vibrations of the electric motor 160 at the desired frequency. It is noted that, in some embodiments, a combination of asymmetric and symmetric changes in the radial magnetic force may be induced.

The desired frequency is at or near the resonance frequency of the selected component. It is noted that, the desired frequency may fall within a tolerance of about ±30 Hz of the resonance frequency of the selected component. In some embodiments, this tolerance may vary depending on the selected component. For example, the desired frequency may be within about ±30 Hz of the resonance frequency of the driver straddle seat 142 and about ±10 Hz of the resonance frequency of the handlebar assembly 142. In the present embodiment, the driver straddle seat 142 is composed of a softer material compared to the handlebar assembly 152. Thus, the handlebar assembly 152 has a higher resonance frequency than the driver straddle seat 140, such that the handlebar assembly 152 vibrates at higher frequencies (e.g., approximately 100 Hz) while the driver straddle seat 140 vibrates at lower frequencies. It is contemplated that, in alternative embodiments, the driver straddle seat 140 may vibrate at higher frequencies while the handlebar assembly 152 may vibrate at lower frequencies.

In this embodiment, step 306 further includes the controller 200 modulating the magnetizing current component to produce distinct vibrations in the selected component (depicted in FIG. 9). This modulation allows the vibrations to be tailored to the condition signal, conveying different information to the driver through the vibrations. In certain embodiments, the controller 200 may modulate the magnetizing current component to produce different vibrations in the selected component based on the condition signal to relay different information to the driver. In certain embodiments, the controller 200 may modulate the magnetizing current component to vibrate the selected component in a vibration pattern based on the condition signal. In some embodiments, the controller may modulate a frequency of the magnetizing current component, thereby causing the frequency of the vibrations to increase or decrease. In some embodiments, the controller 200 may modulate an amplitude of the magnetizing current component, thereby causing the strength or intensity of the vibrations to increase or decrease. This allows for different conditions of the electric vehicle 100 to be communicated to the driver, not only through the selected component, but also through the vibration pattern, change in vibration frequency, and/or change in vibration intensity.

The method 300 continues, at step 308, with the controller 200 applying the adjusted magnetizing current component to the electric motor 160 to vibrate the electric motor 160 at the desired frequency.

It is noted that, as the method 300 adjusts the magnetizing current component to generate vibrations, it can be performed independently of the torque output of the electric motor 160. In other words, the torque output is not affected while the method 300 is being performed, ensuring the driver experience remains unchanged. Additionally, using the method 300 to generate vibrations eliminates the need for an additional motor for generating vibrations, thereby reducing manufacturing complexity, cost, and weight of the electric vehicle 100.

In alternative embodiments, the method 300 may involve the controller 200 adjusting and/or modulating the torque current component. For instance, the controller 200 may add oscillations of the torque current component (depicted in FIG. 9). In some cases, the controller 200 may modulate the torque current component to have a vibrational pattern, a change in frequency, and/or a change in intensity in the selected component, similar to the approach described above with respect to the magnetizing current component (i.e., at step 306). In this instance, the rotor 166 would generate the vibrations at the desired frequency.

Although the electric vehicle 100 has been described as a two-wheeled electric motorcycle 100, the method 300 may be implemented in any electric vehicle 100 including, but not limited to, a three-wheeled electric vehicle and an electric personal watercraft.

Modifications and improvements to the above-described embodiments of the present technology may become apparent to those skilled in the art. The foregoing description is intended to be exemplary rather than limiting. The scope of the present technology is therefore intended to be limited solely by the appended claims.

What is claimed is:

1. A method for generating vibrations in an electric vehicle having an electric motor for propelling the electric vehicle, the method comprising:
providing, by a controller of the electric vehicle, a signal for operating the electric motor;
selecting, by the controller, one of a first driver-contacting component or a second driver-contacting component to be vibrated;
adjusting, by the controller, the signal for causing vibration of the electric motor at a desired frequency, the desired frequency being at or near a resonance frequency of the one of the first driver-contacting component or the second driver-contacting component; and
applying, by the controller, the adjusted signal to the electric motor.

2. The method of claim 1, further comprising detecting, by at least one condition sensor operatively connected to the controller, at least one condition of the electric vehicle.

3. The method of claim 2, further comprising:
receiving, by the controller, a condition signal indicative of the at least one detected condition of the electric vehicle; and
wherein selecting the one of the first driver-contacting component or the second driver-contacting component and adjusting the signal is based on the condition signal.

4. The method of claim 3, wherein adjusting the signal comprises modulating the signal to cause the one of the first driver-contacting component or the second driver-contacting component to vibrate in a vibration pattern based on the condition signal.

5. The method of claim 3, wherein adjusting the signal comprises modulating a frequency of the signal based on the condition signal.

6. The method of claim 3, wherein adjusting the signal comprises modulating an amplitude of the signal based on the condition signal.

7. The method of claim 1, wherein:
the first driver-contacting component is at least one of a left handle, a right handle, or a handlebar of the electric vehicle; and
the second driver-contacting component is a driver seat of the electric vehicle.

8. The method of claim 7, wherein:
the first driver-contacting component has a first resonance frequency;
the second driver-contacting component has a second resonance frequency; and
the first resonance frequency is higher than the second resonance frequency.

9. The method of claim 1, wherein:
the signal is a magnetizing current component; and
adjusting the signal comprises adding an adjustment value to the magnetizing current component.

10. The method of claim 1, further comprising:
detecting, by at least one drive system sensor operatively connected to the controller, at least one drive system parameter of the electric vehicle; and
wherein the at least one detected drive system parameter is at least one of a motor load, high vehicle acceleration, a rotor angular position, vehicle operation limits, a driving mode, and a drivetrain operating parameter.

11. The method of claim 10, further comprising:
receiving, by the controller, a drive system signal indicative of the at least one detected drive system parameter; and
wherein adjusting the signal to the adjusted signal is performed based on the drive system signal.

12. The method of claim 1, wherein the method is performed independently of a torque output of the electric motor.

13. An electric vehicle comprising:
a vehicle body;
an electric motor mounted to the vehicle body for driving the electric vehicle;
a first driver-contacting component connected to the vehicle body the first driver-contacting component having a first resonance frequency;
a second driver-contacting component connected to the vehicle body, the second driver-contacting component having a second resonance frequency; and
a controller operatively connected to the electric motor, the controller being configured for:
providing a signal for operating the electric motor;
selecting one of the first driver-contacting component or the second driver-contacting component to be vibrated; and
adjusting the signal for causing vibration of the electric motor at a desired frequency that is at or near the first resonance frequency or the second resonance frequency corresponding to the one of the first driver-contacting component or the second driver-contacting component; and
applying the adjusted signal to the electric motor.

14. The electric vehicle of claim 13, wherein:
the first driver-contacting component is at least one of a left handle, a right handle, or a handlebar; and
the second driver-contacting component is a driver seat.

15. The electric vehicle of claim 13, further comprising at least one condition sensor operatively connected to the controller for detecting at least one condition of the electric vehicle.

16. The electric vehicle of claim 15, wherein the controller is further configured for:
receiving a condition signal from the at least one condition sensor indicative of the at least one detected condition of the electric vehicle; and
wherein selecting the one of the first driver-contacting component or the second driver-contacting component and adjusting the signal is based on the condition signal.

17. The electric vehicle of claim 16, wherein, when the controller is adjusting the signal, the controller is further configured for modulating the signal to cause the one of the first driver-contacting component or the second driver-contacting component to vibrate in a vibration pattern based on the condition signal.

18. The electric vehicle of claim 16, wherein, when the controller is adjusting the signal, the controller is further configured for modulating at least one of a frequency and an amplitude of the signal.

19. The electric vehicle of claim 13, further comprising:
at least one drive system sensor for detecting a drive system parameter of the electric vehicle; and
wherein the controller is further configured to:
receive a drive system signal from the at least one drive system sensor indicative of the at least one detected drive system parameter; and
adjusting the signal in response to the detected drive system parameter.

20. The electric vehicle of claim 13, wherein:
the vehicle body comprises:
a frame having;
a pair of frame members; and
a swing arm pivotally connected to the pair of frame members;
the electric motor is mounted to the swing arm;
the electric vehicle further comprises at least one ground-engaging member operatively connected to the swing arm;
the electric vehicle is an electric motorcycle;
the at least one ground-engaging member comprises a front ground-engaging member and a rear ground-engaging member; and
the electric motor is operatively connected to the rear ground-engaging member for driving the rear ground-engaging member.
